(19) United States
(12) Patent Application Publication
(10) Pub. No.: US 2017/0109111 A1
(43) Pub. Date: Apr. 20, 2017

(54) DISTRIBUTED-NETWORK SYSTEM OF EFFICIENTLY ALLOCATING USERS OF A PRINT AWARENESS TOOL BASED ON PRINT USAGE

(71) Applicant: Xerox Corporation, Norwalk, CT (US)

(72) Inventor: Fritz Francis Ebner, Pittsford, NY (US)

(21) Appl. No.: 14/883,764

(22) Filed: Oct. 15, 2015

(51) Int. Cl. G06F 3/12; H04N 1/00

(52) U.S. Cl. CPC G06F 3/1262; G06F 3/1203; G06F 3/1211; G06F 3/1288; H04N 1/00352; G06F 3/1273; H04N 2201/0094

(57) ABSTRACT

A distributed-network system for allocating users of a print awareness tool includes: an electronic device, a plurality of print production devices, and a computer-readable storage medium. The computer-readable storage medium has one or more programming instructions that are configured to cause the electronic device to identify a plurality of users of a print awareness tool, receive print information corresponding to the identified users, apply a clustering algorithm to create one or more groupings, determine a number of groups per grouping based on the groupings, and create the grouping having the determined number of groups.

### BACKGROUND

Print awareness tools provide real-time information to users about their print behavior and can be used to identify opportunities to improve efficiency. Print awareness tools, such as the Xerox® Print Awareness Tool, can provide a user interface through which a user can track print usage, monitor a print savings account which shows how much the user is saving each month in printing costs, or access a reward system that encourages print reductions.

Currently, print awareness tool users are populated into user groups, such as, for example, departments or peer groups, through an import function or manually through a portal, which are both time intensive and inefficient approaches.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. As used herein, the term “comprising” means “including, but not limited to.”

In an embodiment, a distributed-network system for allocating users of a print awareness tool includes: an electronic device, a plurality of print production devices, and a computer-readable storage medium. The computer-readable storage medium has one or more programming instructions that are configured to cause the electronic device to identify a plurality of users of a print awareness tool, receive print information corresponding to the identified users, apply a clustering algorithm to create one or more groupings, determine a number of groups per grouping based on the groupings, and create the grouping having the determined number of groups. The system may receive print information from a transceiver of a print production device via a communication protocol that includes, for each identified user, a measurement of savings accumulated by the user based on print history over a period of time, and a level of print activity permitted for the user over a second period of time. The system may create one or more groupings based on one or more of the received group parameters, and each grouping includes one or more groups that each include one or more data points corresponding to the received print information.

Optionally, the system applies a k-means clustering algorithm to create one or more groupings.

Optionally, the system determines a number of groups per grouping by determining a sum of within-group sum of squared differences.

In an embodiment, the system determines a number of groups per grouping by selecting the grouping that accounts for a threshold of a sum of the squares error reduction.

Optionally, the system creates the grouping having the determined number of groups by, for each group having a number of users that is less than a minimum number of users, merging the group with another group that is nearest to the group.

In an embodiment, the system creates the grouping having the determined number of groups by, for each group in the created grouping, identifying the users associated with the group, and causing print information corresponding to the identified users to be associated in memory.

Optionally, the computer-readable storage medium further comprises one or more programming instructions that are configured to cause the electronic device to, for each group in the created grouping, cause a visual representation of the print information for users in the group to be displayed to the users.

In an embodiment, one or more of the print production devices includes one or more programming instructions that are configured to cause a port of the one or more print production devices to receive one or more print jobs from one or more spoolers of one or more user electronic devices.

### BRIEF DESCRIPTION OF THE DRAWINGS

FIG. 1 illustrates an example distributed network system of allocating print awareness tool users according to an embodiment.

FIG. 2 illustrates an example method of allocating users of a print awareness tool implemented in a distributed network according to an embodiment.

FIGS. 3A and 3B illustrate example scatter plots of quota information and savings information as raw data and as scaled data according to various embodiments.

FIG. 4 illustrates a block diagram of example hardware that may be used to contain or implement program instructions according to an embodiment.

### DETAILED DESCRIPTION

The following terms shall have, for purposes of this application, the respective meanings set forth below:

A “computing device” or “electronic device” refers to a device that includes a processor and non-transitory, computer-readable memory. The memory may contain programming instructions that, when executed by the processor, cause the computing device to perform one or more operations according to the programming instructions. As used in this description, a “computing device” or “electronic device” may be a single device, or any number of devices having one or more processors that communicate with each other and share data and/or instructions. Examples of computing devices or electronic devices include, without limitation, personal computers, servers, mainframes, gaming systems, televisions, and portable electronic devices such as smartphones, personal digital assistants, cameras, tablet computers, laptop computers, media players and the like.

A “print awareness tool” or “tool” refers to a computer-implemented platform that monitors and/or reports the printing activity of one or more users.

A “print production device” refers to a device used to process at least a portion of a print job. Examples of print production devices may include, without limitation, printers, inserters, binders, punchers, collators, multi-function devices or other similar equipment and/or the like.

In various embodiments, an organization such as, for example, a business or other organization, may utilize a print awareness tool to monitor the printing activities of one or more users such as, for example, its employees. A print awareness tool may help a user understand the true impact of the user's print activity on the environment, and may assist a user in making better choices about what and how to print.

A print awareness tool may use incentives to motivate users to print less and less frequently. For instance, a print awareness tool may assign a print point budget to a user over a period of time such as, for example, on a monthly basis. Certain print activities may be worth certain points, which may be deducted from a user's print point budget when they occur. For instance, a user may be assigned a print point balance of 1,000 points for a particular month. Printing documents in excess of ten pages may incur a cost of 25 points, whereas printing documents in excess of 50 pages may incur a cost of 100 points. Similarly, printing documents in a single-sided format may incur more points than printing in a duplex fashion. Additional and/or alternate point values and activity allocations may be used within the scope of this disclosure.

As a user performs certain printing activities that are associated with point values, the allocated point values may be deducted from the user's total print point balance. A print awareness tool may rank users based on their print point balances to allow users the ability to see where how their printing activities compare to those of other users. This provides motivation for users to reduce their printing activities, and also provides competition amongst groups of users.

In various embodiments, a print awareness tool may automatically group users into groups based on similar print performance. A group that encompasses all system users may be cumbersome depending on the number of users. Categorizing users into similarity groups may create a more interesting comparison for users, and may provide them with more of an incentive to improve.

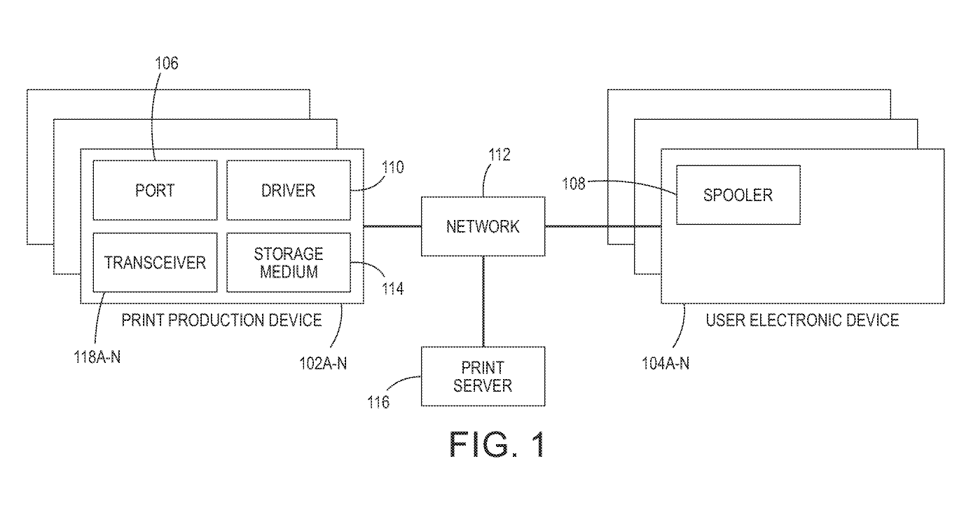

FIG. 1 illustrates an example distributed network system of allocating print awareness tool users according to an embodiment. As illustrated by FIG. 1, a system 100 may include one or more print production devices 102a-N. Print production devices 102a-N may include, without limitation, printers, multi-function devices, scanners and/or the like. As illustrated by FIG. 1, one or more print production devices 102a-N may be in network communication with one or more user electronic devices 104a-N. A user electronic device 104a-N may include, without limitation, a computer, a tablet, a mobile device and/or the like.

In an embodiment, one or more print production devices 102a-N may include one or more ports, such as, for example, an input/output (I/O) port 106. One or more user electronic devices may include one or more spoolers 108. In an embodiment, a spooler 108 may send a print job, in the form of a data stream, to a driver 110 associated with a print production device's I/O port 106. A driver 110 may be a serial port driver, a parallel port driver, a network port driver and/or the like.

In another embodiment, a print production device 102a-N may include one or more transceivers 118a-N for sending and/or receiving electronic documents or other print jobs. For example, a transceiver 118a-N may receive print jobs from one or more user electronic devices 104a-N and/or send print jobs to one or more user electronic devices.

As illustrated by FIG. 1, one or more user electronic devices 104a-N may communicate with one or more other user electronic devices via a communication network 112. A communication network 112 may be a local area network (LAN), a wide area network (WAN), a mobile or cellular communication network, an extranet, an intranet, the Internet and/or the like.

In certain embodiments, a print production device 102a-N may include a non-transitory storage medium 114 that may store print job information. Print job information may include, without limitation, a size of a print job, content or data associated with a print job, a user who submitted a print job, a time a print job was received, a time a print job was processed and/or the like.

In an embodiment, a system 100 may include one or more print servers 116. A print server may be in communication with one or more user electronic devices 104a-N and/or one or more print production devices 102a-N via a communication network 112.

In various embodiments, the system illustrated in FIG. 1 may be implemented as a distributed network system. One or more user electronic devices 104a-N may be located remotely from one or more other user electronic devices, one or more print servers, and/or one or more print production devices 102a-N such as, for example, in a different department, on a different floor, in a different building or even in a different geographic location. Likewise, one or more print production devices 102a-N may be located remotely from one or more other print production devices and/or print servers.

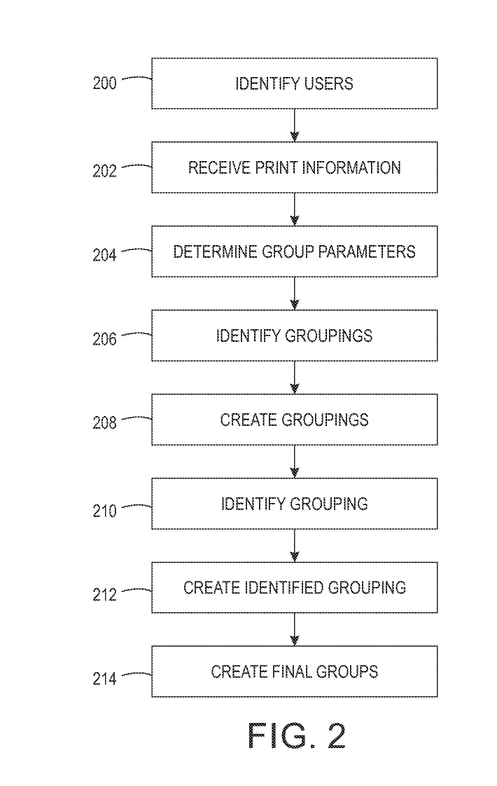

FIG. 2 illustrates an example method of allocating users of a print awareness tool implemented in a distributed network according to an embodiment. As illustrated by FIG. 2, an electronic device may identify 200 one or more print awareness tool users. An electronic device may identify 200 all users or a subset of all users. For instance, only users associated with a certain location, department, group, or other characteristic may be identified. An electronic device may identify 200 users based on input from a tool operator or administrator. In another embodiment, an electronic device may identify 200 users from a database or other storage medium in communication with the electronic device.

In an embodiment, an electronic device may receive 202 print information for one or more tool users. Print information may include, without limitation, savings information and/or quota information for a particular user. Savings information refers to a measurement of savings that a user accumulated for the user's printing history over a period of time. Savings information may include a number of points accumulated by a user or another measurement. For instance, if a user prints a volume over a period of time that is less than a quota associated with that period of time, the user may accumulate points. Similarly, if a user prints less frequently than a certain quota over a period of time, the user may accumulate points.

Quota information refers to a level of print activity permitted for a user over a period of time. For example, a user may be able to print 1,000 per month or 20 print jobs per month. Additional and/or alternate quotas may be used within the scope of this disclosure.

An electronic device may receive 202 print information from one or more other electronic devices. For instance, an electronic device may receive 202 print information from one or more user electronic devices associated with the identified user(s) to which the print information corresponds and/or one or more print production devices.

A user electronic device and/or a print production device may maintain one or more electronic data files that include print information and an indication of a user to which the print information corresponds. For instance, a user electronic device and/or a print production device may assign each user a unique identifier, and may store print information for the user in an electronic data file so that it is associated with the unique identifier. For instance, a user electronic device and/or a print production device may store print information pertaining to the same user in a same memory location or locations that have been allocated to the user. In another embodiment, an electronic data file associated with a user may include a pointer to a memory location where print information associated with the user is stored.

An electronic device may receive an electronic data file from a user electronic device and/or a print production device. A user electronic device and/or a print production device may transmit one or more electronic data files or other data via one or more communication protocols. An electronic device, one or more user electronic devices and/or one or more print production devices may be communicatively connected via one or more communication protocols such as via a Transmission Control Protocol/Internet Protocol (TCP/IP), a Wi-Fi network, via another communication network such as a mobile phone network, or using short-range or near-field communications protocols such as Bluetooth, Bluetooth Low Energy, radio frequency identification (RFID) or other protocols.

In various embodiments, a print production device may be communicatively connected to one or more electronic devices via one or more printing protocols such as, for instance, a Internet Printing Protocol (IPP), a Line Printer Daemon (LPD) protocol, a Line Printer Remote (LPR) protocol and/or the like.

As illustrated by FIG. 2, an electronic device may determine 204 one or more group parameters. A group parameter may be a characteristic of one or more print awareness tool user groups to be allocated. Example group parameters may include, without limitation a minimum and/or maximum number of users per user group, a minimum and/or maximum number of user groups, and/or the like.

In an embodiment, an electronic device may identify 206 a range of groupings to investigate based on one or more of the group parameters. For example, an electronic device may identify 206 a range of groupings that is between a minimum number of groupings and a maximum number of groupings, if specified by one or more group parameters.

In an embodiment, an electronic device may create 208 a range of groupings equal to the identified number. Each grouping may include one or more groups of data points associated with the received print information. An electronic device may use a clustering algorithm to create 208 the groupings. Example clustering algorithms include, without limitation, hierarchical clustering algorithms, centroid-based clustering algorithms, distribution-based clustering algorithms, density-based clustering algorithms and/or the like. An example centroid-based clustering algorithm is k-means clustering.

K-means clustering involves partitioning n observations into k clusters in which each observation belongs to the cluster with the nearest mean. For example, given a set of observations (x₁, x₂, . . . , xₙ), k-means clustering involves partitioning the n observations in k<=n clusters C={C₁, C₂, . . . , Cₖ} so as to minimize the within-cluster sum of squares.

In an embodiment, an electronic device may use k-means clustering to organize the received print information for identified tool users into groups. A print information data point, such as, for example, savings information and/or quota information for a user, may be considered an observation for k-means clustering. For instance, an electronic device may create a scatter plot of print information for identified users from which groups may be created. As an example, an electronic device may create a scatter plot of quota information and savings information, and these data points may be used to form groups.

In certain embodiments, an electronic device may scale and center savings information and/or quota information before applying k-means clustering. This serves to normalize savings information in relation to quota information as savings values tend to grow over time, but quota values are likely to remain constant or decrease.

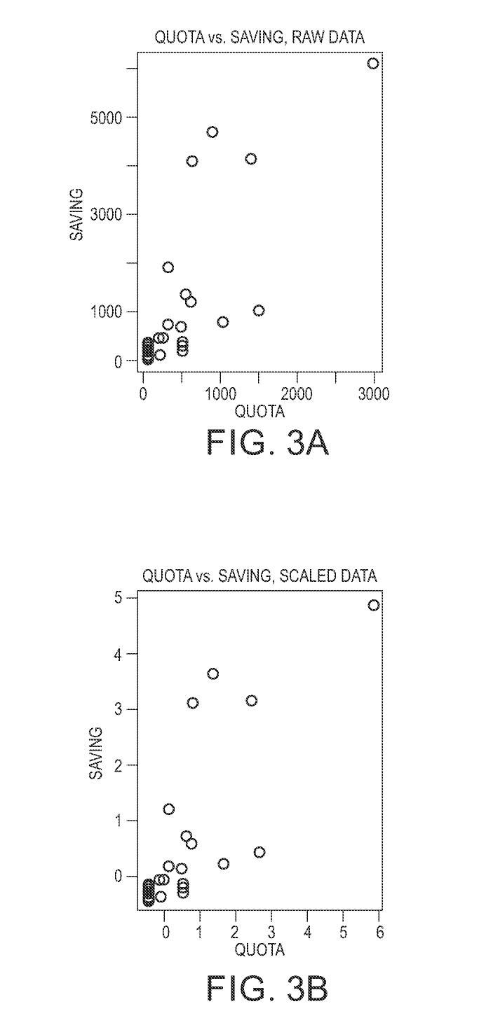

FIGS. 3A and 3B illustrate example scatter plots of quota information and savings information as raw data and as scaled data according to an embodiment.

In an embodiment, an electronic device may identify 210 a grouping from the range of groupings. The identified grouping may include groups having a minimal group size. An electronic device may determine, for each grouping, the sum of within-cluster sum of squared differences of the groups within the grouping. The electronic device may select the grouping that can account for a certain threshold of the sum of the squares error reduction. A sum of squares error may be represented by sum

$$( {( x - \overline{x} )}^{2} ) ,$$

and may be a measure of error between groups and/or within groups. In an embodiment, the group sum of square error may be minimized. For instance, an electronic device may select the grouping that can account for >=95% of the sum of squares error reduction. Additional and/or alternate threshold values may be used within the scope of this disclosure.

An electronic device may create 212 the identified grouping, and may create 214 final groups within the grouping. In an embodiment, an electronic device may create 214 final groups by sorting the groups within the grouping by number of users, from small to large. For each group, the electronic device may determine whether the number of users in the group is less than a minimum number of users per group. If so, the electronic device may merge the group with a group having the nearest centroid (i.e., the nearest group). In certain embodiments, a minimum number of users per group may be specified by a user, administrator and/or the like.

In an embodiment, an electronic device may create 214 final groups by identifying the users associated with the print information data points of the group, and causing print information associated with each identified user to be associated in memory. For instance, an electronic device may cause print information associated with users in a group to be moved from a current memory location to a different memory location where it may be accessed by members of the group. In another embodiment, an electronic device may cause a flag, a pointer, or another indicator to be stored in one or more data entries of print information for a user that indicates to which group the user belongs to. Additional and/or alternate associations may be used within the scope of this disclosure.

The grouping approach described in this disclosure results in print awareness tool users with similar print information being grouped together for purposes of tool usage. This may provide a more meaningful user experience and may incentivize users through competition with similarly-situated tool users to reduce their print activities. In certain embodiments, the user groups may include users across geographic locations, departments, divisions and/or the like. As such, user groups may be determined based on print activity rather than organization hierarchies or proximity.

In various embodiments, an electronic device may present the groups to a tool user, administrator and/or the like. For instance, an electronic device may cause a dashboard or other graphical user interface to be displayed that indicates users of one or more groups, print information associated with one or more users and/or the like. In certain embodiments, an electronic device may prevent a user that is not a member of a group and that is not a tool administrator from seeing print information associated with users of the group. For instance, an electronic device may prevent a non-group member from accessing one or more particular memory locations where print information associated with one or more group members is stored.

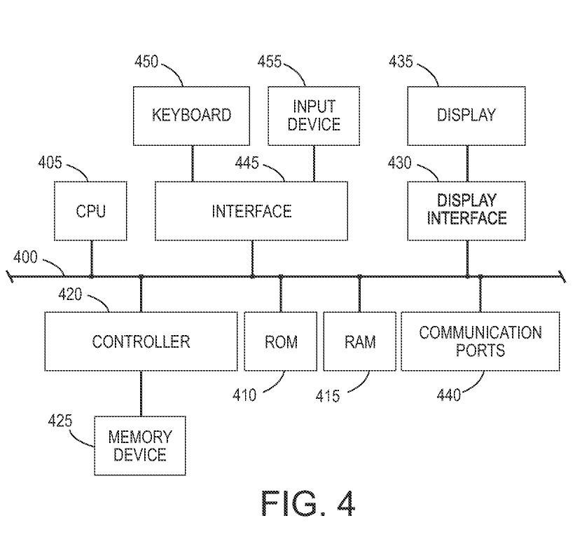

FIG. 4 depicts a block diagram of hardware that may be used to contain or implement program instructions. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an example of a production device, computing device or processor as such terms are used within this disclosure.

CPU 405 represents one or more processors that perform calculations and logic operations required to execute a program. Any number of processors may be available, and they may be part of a single electronic device or distributed across any number of networked electronic devices. The processor(s) may access a computer-readable memory device 425 containing programming instructions.

When this document and any claim uses the term “processor,” then unless specifically stated otherwise it is intended to refer to all such embodiments (i.e., single processor or multiple processors). When this document or any claim in the document uses the term “computer-readable memory,” “computer-readable medium,” or similar phrases, then unless specifically stated otherwise it is intended to refer to embodiment that include a single device, embodiments in which data is distributed across multiple devices, and embodiments relating to various sectors of a single device. Read only memory (ROM) 410 and random access memory (RAM) 415 constitute examples of non-transitory computer-readable storage media.

A controller 420 interfaces with one or more optional non-transitory computer-readable storage media 425 to the system bus 400. These storage media 425 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 410 and/or the RAM 415. Optionally, the program instructions may be stored on a tangible, non-transitory computer-readable medium such as a compact disk, a digital disk, flash memory, a memory card, a USB drive, an optical disc storage medium and/or other recording medium.

An optional display interface 430 may permit information from the bus 400 to be displayed on the display 435 in audio, visual, graphic or alphanumeric format. Communication with external devices, such as a printing device, may occur using various communication ports 440. A communication port 440 may be attached to a communications network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device.

It will be appreciated that the various above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

1. A distributed-network system for allocating users of a print awareness tool, the system comprising:
an electronic device;
a plurality of print production devices; and
a computer-readable storage medium comprising one or more programming instructions that are configured to cause the electronic device to:
identify a plurality of users of a print awareness tool,
receive, from a transceiver of a print production device via a communication protocol, print information corresponding to the identified users, wherein the print information comprises, for each identified user:
a measurement of savings accumulated by the user based on print history over a period of time, and 'a level of print activity permitted for the user over a second period of time,
determine one or more group parameters, wherein each of the one or group parameters is a characteristic of user groups to be allocated,
apply a clustering algorithm to the received print information to create one or more groupings based on one or more of the determined group parameters, wherein each grouping comprises one or more groups that each comprise one or more data points corresponding to the received print information,
determine a number of groups per grouping based on the groupings, and
create the grouping having the determined number of groups.

2. The system of claim 1, wherein the one or more programming instructions that are configured to cause the electronic device to apply a clustering algorithm comprise one or more programming instructions that are configured to cause the electronic device to apply a k-means clustering algorithm.

3. The system of claim 1, wherein the one or more programming instructions that are configured to cause the electronic device to determine a number of groups per grouping based on the groupings comprise one or more programming instructions that are configured to cause the electronic device to, for each grouping, determine a sum of within-group sum of squared differences.

4. The system of claim 1, wherein the one or more programming instructions that are configured to cause the electronic device to determine a number of groups per grouping based on the groupings comprise one or more programming instructions that are configured to cause the electronic device to select the grouping that accounts for a threshold of a sum of the squares error reduction.

5. The system of claim 1, wherein the one or more programming instructions that are configured to cause the electronic device to create the grouping having the determined number of groups comprise one or more programming instructions that are configured to cause the electronic device to, for each group having a number of users that is less than a minimum number of users, merging the group with another group that is nearest to the group.

6. The system of claim 1, wherein the one or more programming instructions that are configured to cause the electronic device to create the grouping having the determined number of groups comprise one or more programming instructions that are configured to cause the electronic device to, for each group in the created grouping:
identify the users associated with the group; and
cause print information corresponding to the identified users to be associated in memory.

7. The system of claim 1, wherein the computer-readable storage medium further comprises one or more programming instructions that are configured to cause the electronic device to, for each group in the created grouping, cause a visual representation of the print information for users in the group to be displayed to the users.

8. The system of claim 1, wherein one or more of the print production devices comprises one or more programming instructions that are configured to cause a port of the one or more print production devices to receive one or more print jobs from one or more spoolers of one or more user electronic devices.

9. A method for allocating users of a print awareness tool in a distributed-network system, the method comprising:
identifying a plurality of users of a print awareness tool;
receiving, from a transceiver of a print production device via a communication protocol, print information corresponding to the identified users, wherein the print information comprises, for each identified user:
a measurement of savings accumulated by the user based on print history over a period of time, and
a level of print activity permitted for the user over a second period of time;
determining one or more group parameters, wherein each of the one or group parameters is a characteristic of user groups to be allocated;
applying a clustering algorithm to the received print information to create one or more groupings based on one or more of the determined group parameters, wherein each grouping comprises one or more groups that each comprise one or more data points corresponding to the received print information;
determining a number of groups per grouping based on the groupings; and
creating the grouping having the determined number of groups.

10. The method of claim 9, wherein applying a clustering algorithm comprises applying a k-means clustering algorithm.

11. The method of claim 9, wherein determining a number of groups per grouping based on the groupings comprises, for each grouping, determine a sum of within-group sum of squared differences.

12. The method of claim 9, wherein determining a number of groups per grouping based on the groupings comprises selecting the grouping that accounts for a threshold of a sum of the squares error reduction.

13. The method of claim 9, wherein creating the grouping having the determined number of groups comprises, for each group having a number of users that is less than a minimum number of users, merging the group with another group that is nearest to the group.

14. The method of claim 9, wherein creating the grouping having the determined number of groups comprises, for each group in the created grouping:
identifying the users associated with the group; and
causing print information corresponding to the identified users to be associated in memory.

15. The method of claim 9, further comprising, for each group in the created grouping, causing a visual representation of the print information for users in the group to be displayed to the users.
